(19) United States
(12) Patent Application Publication
(10) Pub. No.: US 2026/0357037 A1
(43) Pub. Date: Nov. 12, 2026

(54) AQUEOUS ACOUSTIC DAMPING COMPOSITIONS, AND ARTICLES AND ASSEMBLIES THEREFROM

(71) Applicant: Henkel AG & Co. KGaA, Duesseldorf (DE)

(72) Inventors: ChongYu Zhu, Shanghai-Zhangjiang (CN); Qi Chen, Shanghai-Zhangjiang (CN); Yuan Zhao, Shanghai-Zhangjiang (CN); Chris JinFeng Zhong, Shanghai (CN); XueWen Zhang, Shanghai-Zhangjiang (CN)

(21) Appl. No.: 19/387,959

(22) Filed: Nov. 13, 2025

Related U.S. Application Data
(63) Continuation of application No. PCT/CN2023/096041, filed on May 24, 2023.

(51) Int. Cl. C08K 3/26; C08K 5/11

(52) U.S. Cl. CPC C08K 3/26; C08K 5/11; C08K 2003/265

(57) ABSTRACT

This invention relates to an aqueous acoustic damping composition comprising an acrylic polymer, at least a filler, a starch, an anti-shocking agent and a rosin ester, wherein the anti-shocking agent is an ester based anti-shocking agent; the aqueous acoustic damping composition may be used as acoustic damping coating, for example, in automotive industrial aqueous liquid applied acoustic damping applications, to provide anti-shocking performance at low temperature (less than −20 °C), and good acoustic performance at the same.

### TECHNICAL FIELD

The present disclosure relates to aqueous acoustic damping compositions for motor vehicle applications, articles and assemblies therefrom, especially an aqueous acoustic damping composition with good anti-shocking performance at low temperature. The aqueous acoustic damping compositions can be used, for example, in automotive industrial applications.

### BACKGROUND OF THE INVENTION

Acoustic damping materials, such as manual applied sound deadening patches using asphalt pads, have been facilitated in various industrial appliances and vehicles to suppress the noise caused by vibration. To save labor work during installation and replacement, sprayable polymer based acoustic damping compositions, also known as liquid-applied acoustic damping (LASD) materials, have been developed accordingly. Possessing a higher damping efficiency and better odour, LASD offers a reduced application amount and a facile application through robotic controlled applicator guns, which is more compatible to automatic, light-weighted, and environmentally friendly design.

LASD compositions can be characterized as either aqueous or non-aqueous systems. In comparison to non-aqueous LASD coatings, aqueous systems have undoubted advantages such as easier design, wider damping range, less VOC emission, and lower cost. However, their drying performance in bakeable or air-dried conditions is often with narrow temperature window and may often lead to large blisters and cracks. Also, the adhesion of aqueous LASD coatings can be greatly affected by the targeted surfaces.

With the increase demand of new energy vehicles, the demand of LASD market in this field is expected to have drastic increase. Yet, higher test standards have been proposed by original equipment manufacturers (OEMs) as the application in vehicles requires the reliability of LASD against changeable surroundings, for instance, at low temperature and high humidity. As the damping performance of LASD materials are greatly relied on the glass transition temperature (Tg) of the incorporated polymer latex resin, the Tg of the polymers is often in the range of around room temperature (−2 °C to 25 °C). Hence, the polymers will get brittle at lower temperature, for instance, −10 °C to −30 °C, or −20 °C to −30 °C, so that the LASD will form deep cracks or even fall off from the substrate in response to shock at such low temperature. Although the addition of conventional plasticizers could reduce the Tg of the polymers, giving a better anti-shocking performance at low temperature, the acoustic performance of the final product will often be compromised accordingly. Thus, the development of aqueous LASD composition with good acoustic performance and good anti-shocking performance at low temperature is demanding.

### SUMMARY OF THE INVENTION

It is therefore the object of the present invention to overcome the above-mentioned drawbacks by providing an aqueous LASD composition with both good anti-shocking performance at low temperature (equal to or less than −20 °C), and good acoustic & vibration damping performance at ambient temperature (−10 °C~60 °C).

It has been surprisingly found that aqueous acoustic damping composition prepared from a curable aqueous composition comprising at least an acrylic polymer; at least a filler; a starch, an ester based anti-shocking agent and a rosin ester, which provides very good balance between the damping performance and anti-shocking performance at low temperature.

According to one aspect, the present invention relates to a curable damping coating composition, comprising: a) an acrylic polymer, b) at least a filler, c) a starch, d) an anti-shocking agent, and e) a rosin ester, wherein the anti-shocking agent being an ester based anti-shocking agent.

According to one aspect, the present invention is directed to a damping coating comprising a cured product of the aqueous acoustic damping composition according to present invention.

According to still another aspect, the present invention also relates to an article comprising a substrate and a damping coating disposed on the substrate and the second substrate, wherein the damping coating is the cured product of the aqueous acoustic damping composition according to present invention.

According to still another aspect, the present invention also relates to an automotive panel, comprises an article of present invention.

### BRIEF DESCRIPTION OF THE DRAWINGS

FIG. 1 shows a graph comparing the damping coefficient measurement results of Examples and Comparative Examples as disclosed herein.

### DETAILED DESCRIPTION OF THE INVENTION

In the following passages the present invention is described in more detail. Each aspect so described may be combined with any other aspect or aspects unless clearly indicated to the contrary. In particular, any feature indicated as being preferred or advantageous may be combined with any other feature or features indicated as being preferred or advantageous.

In the context of the present invention, the terms used are to be construed in accordance with the following definitions, unless a context dictates otherwise.

As used herein, the singular forms “a”, “an” and “the” include both singular and plural referents unless the context clearly dictates otherwise. For example, reference to “a filler” encompasses embodiments having one, two or more fillers. As used in this specification and the appended claims, the term “or” is generally employed in its sense including “and/or” unless the content clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or process steps.

The term “ambient temperature” refers to a temperature in the range of −10 °C to 60 °C, inclusive.

The term “low temperature” refers to a temperature in the range of equal to or less than −20 °C, preferably −30 °C to −20 °C, inclusive.

The recitation of numerical end points includes all numbers and fractions subsumed within the respective ranges, as well as the recited end points.

Unless otherwise defined, all terms used in the disclosing the invention, including technical and scientific terms, have the meaning as commonly understood by one of the ordinary skills in the art to which this invention belongs to. By means of further guidance, term definitions are included to better appreciate the teaching of the present invention.

In the context of this disclosure, several terms shall be utilized.

The terms “polymer” is used herein consistent with its common usage in chemistry. Polymers are composed of many repeated subunits. The term “polymer” is used to describe the resultant material formed from a polymerization reaction.

The term “acrylic” refers to both or any one of “acrylic” and “methacrylic”.

The term “acrylate” refers to both or any one of “acrylate” and “methacrylate”.

The term “alkyl” refers to a monovalent group that is a residue of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 20 carbon atoms. In some embodiments, the alkyl groups contain 1 to 15 carbon atoms, 1 to 10 carbon atoms, 1 to 6 carbon atoms, 1 to 4 carbon atoms, or 1 to 3 carbon atoms. Examples of “alkyl” groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, octadecyl, behenyl, adamantyl, norbornyl, and the like.

The terms “curing” is used herein means a process of hardening of a material. The term is intended to encompass the drying of the material through the evaporation of water and co-solvents from the material and also, where applicable, the cross-linking of components within the material which possess reactive groups.

For purposes of this invention, weight average molecular weight (Mw) is determined by gel permeation chromatography against a polystyrene standard.

Viscosities of the composition compositions may be determined using the Brookfield Viscometer, Model RVT at standard conditions of 25 °C and 50% Relative Humidity (RH). The viscometer is calibrated using silicone oils of known viscosities, which vary from 5,000 cps to 300,000 cps. A set of RV spindles that attach to the viscometer are used for the calibration. Measurements of the damping composition are done at 25 °C using the No. 7 spindle at a speed of 20 revolutions per minute for 1 minute until the viscometer equilibrates.

The term “softening point” as used herein refers to the temperature at which a material, such as a polymer, loses its solid characteristics and becomes relatively fluid. A material's softening point as given herein is that temperature measured using the standard ball and ring method according to ASTM E28.

As used herein, the glass transition temperature (Tg) is determined by differential scanning calorimetry (DSC) employing a 20 K/min ramp rate and midpoint measurement in accordance with DIN 53 765.

As discussed previously, embodiments of the present disclosure are directed to an aqueous acoustic damping composition comprising at least an acrylic polymer; at least a filler; a starch, an ester based anti-shocking agent, and a rosin ester. The aqueous acoustic damping composition further comprises a surface-active agent, and/or a thickener, and/or an expandable microsphere, and/or a coalescent agent, and/or a colorant, and/or a biocide, and/or a defoaming agent. And the liquid phase of the aqueous acoustic damping composition includes water.

### Acrylic Polymer

The acrylic polymers suitable for present invention are in dispersed (emulsified) form and may be selected from any of the acrylic polymeric materials conventionally used in aqueous compositions capable of forming vibration and/or damping coatings on substrate surfaces. Preferred acrylic polymers include dispersions of acrylate polymers and copolymers (sometimes referred to in the art as acrylic resins) such as, for example, copolymers of lower alkyl (meth)acrylates such as n-butyl acrylate with comonomers such as styrene and/or acrylonitrile are also preferred for use. Mixtures of the aforedescribed polymers may be used and may be preferred for purposes of obtaining the desired combination of properties in the final cured coating. For example, different polymers having different glass transition temperature characteristics may be used in combination. Generally speaking, the polymers used in the present invention typically have glass transition temperatures in the range of from about −10 °C to about 40 °C, preferably 0 °C to 20 °C. However, in one embodiment of the invention a combination of polymers is used wherein one polymer has a T_{g} greater than 0 °C (e.g., 5 to 35 °C) and another polymer is elastomeric and has a T_{g} less than 0 °C. (e.g., −10 to −30 °C). The two polymers may, for example, both be acrylic resins having different monomer compositions selected to provide the desired T_{g} characteristics.

According to the invention, aqueous dispersions of the acrylic polymer are generally obtained with a solids content of greater than 45% by weight, preferably greater than 50%. In some embodiments of the present invention, the amount of the acrylic polymer in the composition is from 5 to 20 parts by weight, or from 5 to 15 parts by weight, or from 5 to 11 parts by weight, or from 7 to 10 parts by weight.

### Filler

Present invention comprises one or more inorganic fillers in particulate form being incorporated into the aqueous compositions for the purpose of providing bulk to the dried coating, adjusting the hardness of the dried coating, improving the sound or vibration damping properties of the dried coating, controlling blistering of the dried coating, and/or modifying the flammability of the dried coating, among other purposes. The inorganic filler(s) may be in any suitable form such as powder, fibrous, needle-like, scale-like, spherical, plate-like, and other shapes known in the art and should be insoluble in water. The surface of fillers can be either coated with hydrophilic/hydrophobic small molecules/polymer or without any modification. Examples of inorganic fillers suitable for use include, but are not limited to, calcium carbonate, silica, alumina, clay, talc, mica, diatomaceous earth, glass powder or fibers, aluminum hydroxide, perlite, barium sulfate, magnesium carbonate, calcium dihydrate, rock wool, asbestos, wollastonite, zeolite, glass or ceramic microspheres, graphite, and the like and mixtures thereof. Preferred inorganic fillers includes calcium carbonate, silica, alumina.

The inorganic filler is characterized by an average particle diameter (d50) of from 10 to 100 μm and a d95 of from 20 to 200 um.

The amount of inorganic filler in the composition is particularly at least 55 parts by weight, or at least 60 parts by weight, or at least 62 parts by weight, or at least 65 parts by weight, or at least 70 parts by weight, or at least 75 parts by weight, of particulate filler of the composition.

### Starch

The drying control agent minimizes the occurrence of cracks and blistering in the damping composition coating films when the coating films are baked and dried. The use of a polysaccharide drying control agent based on cellulose or starch may be desirable with the use of partial water insoluble starch particularly preferred. Modified cellulose or starch, for example phosphorylated cellulose, with partial solubility in water can also be used. In certain conditions, it may be beneficial to include starch in the compositions in an amount up to 3.5 parts by weight, or up to 5.0 parts by weight of the damping composition.

### Ester-Based Anti-Shocking Agent

The ester-based anti-shocking agents suitable for present invention comprises ester compounds are represented by the following formulas:

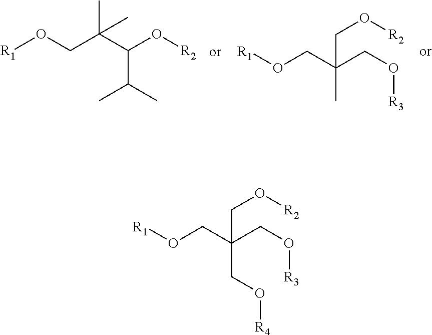

wherein independently, R₁, R₂, R₃ and R₄ each independently represent H or

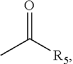

and R₅ represents straight-chain or branched alkyl group having 1 to 18 carbons, preferably 1 to 4 carbons. More preferably R₅ represents at least one of n-propyl, isopropyl, n-butyl and isobutyl. R₁ and R₂ cannot be H simultaneously.

In some embodiments of the present invention, the amount of the ester-based anti-shocking agent in the composition is from 0.3 parts by weight to 6.0 parts by weight, and preferably from 0.4 parts by weight to 5.0 parts by weight, of the composition.

### Rosin Ester

The present composition optionally comprises rosin ester. As used herein, rosin ester refers to chemicals having the following generalized structure: X—C(═O)—O—R, wherein: X is rosin or rosin derivative; and, R represents any organic group.

The “rosin” portion of the rosin ester is, or is derived from, the standard material of commerce known as rosin. Rosin is mainly a mixture of C₂₀, tricyclic fused-ring, monocarboxylic acids: whilst pimaric acid and abietic acid are the predominant acids, any one or more of the C₂₀ cyclic carboxylic acid-containing isomers present in rosin is suitable as the rosin portion of the rosin ester.

In a different expression of preference, which is not intended to be mutually exclusive of the molecular weight condition, it is preferred herein for the or each rosin ester present in the composition to have a softening point of from 40 °C to 130 °C, preferably from 50 °C to 110 °C and more preferably from 50 °C to 90 °C. A particular preference for the use of glycerol and pentaerythritol esters of gum rosins, wood rosins and tail-oil rosins might be noted.

In some embodiments of the present invention, the amount of the rosin ester in the composition is from 0.5 parts by weight to 5.0 parts by weight, or from 1.0 parts by weight to 3.0 parts by weight, or from 1.0 parts by weight to 2.5 parts by weight, of the composition.

### Optional Additives

The compositions of the present invention will typically further comprise optional additives, which are necessarily minor components, but which can nevertheless impart improved properties to these compositions. The total amount of optional additives in the compositions will preferably be up to 10 parts by weight, and more preferably from 0.1 to 10 parts by weight or from 0.1 to 7.5 parts by weight, of the composition. The desired viscosity of the compositions will typically be determinative of the total amount of optional additives added.

Included among such adjunct materials are co-solvents; thickeners; drying control agents; surface-active agents, such as sodium hexametaphosphate, sodium tripolyphosphates or polymer surface-active agents polycarboxylic acids; defoamers; and blowing agents. The aqueous coating compositions of the present invention contain an amount of expandable microspheres effective to improve the surface appearance of the coating formed by heating and drying the composition and/or improve the sound or vibration damping properties of the coating. Expandable microspheres are well known to workers in the field and generally comprise small diameter polymeric shells or bubbles which encapsulate one or more volatile substances such as light hydrocarbons and halocarbons. Suitable expandable microspheres are also available from commercial sources, such as the products sold under the trademark “EXPANCEL” by Casco Nobel AB or Akzo Nobel. The average particle size of the microspheres and temperature at which expansion of the microspheres begins are not believed to be particularly critical. Generally speaking, however, the microspheres will have weight average particle sizes in the range of from about 5 to about 50 microns and onset temperatures of expansion (Tₛₜₐᵣₜ, as measured by thermomechanical analysis) in the range of from about 70 °C to about 160 °C. Mixtures of different expandable microspheres having different average particle sizes and/or different expansion properties may be employed.

### Preparing Method of the Aqueous Acoustic Damping Composition

The aqueous acoustic damping compositions are formulated by simple mixing of the various components. Whilst the order of mixing of the components is not intended to be limited, it may be prudent to first form an aqueous dispersion of the acrylic copolymer and a separate aqueous dispersion of the rosin ester component before mixing said dispersions and the further components. In this scenario, the aqueous dispersion of the rosin ester may, for example, be at a solids content of from 45 to 70 wt. %.

In some embodiments, the aqueous acoustic damping composition comprises from 5.0 to 30.0 parts by weight of water as a liquid phase.

If necessary, the compositions may be prepared well in advance of its application. However, in an interesting alternative embodiment, a concentrated composition may first be obtained by mixing components with only a fraction of the water that would be present in the composition as applied: the concentrated composition may then be diluted with the remaining water shortly before its application. It is considered that such concentrated compositions may be prepared and stored as either single-package concentrates—that can be converted by dilution with water only—or as multi-part concentrates, two or more of which must be combined and diluted to form a complete working composition according to the invention. Any dilution can be affected simply by the addition of water, in particular deionized and/or demineralized water, under mixing. The composition might equally be prepared within a rinse stream whereby one or more streams of the concentrate(s) is injected into a continuous stream of water.

Without specific intention to limit the amount of water included in the aqueous compositions, it is preferred that said compositions contain from 5 to 20 wt. %, preferably from 5 to 15 wt. %, based on the weight of the composition, of water. In an alternative but not mutually exclusive characterization, the composition may be defined by a viscosity of from 10 to 300 Pa·s, for example 50 to 200 Pa·s, as measured using a Brookfield viscometer at 25 °C.

In accordance with the broadest process aspects of the present invention, the above-described compositions are applied to a substrate and then cured in situ.

There is no particular intention to the limit the substrates to which the present compositions may be applied. In application to vehicular panels, exemplary substrates may be metallic, polymeric or combinations thereof. However, particular mention may be made of: ferrous metals, such as iron, steel, and alloys thereof; nonferrous metals, such as aluminum, zinc and alloys thereof; and, combinations thereof. In illustrative embodiments, the substrate may be formed from: cold rolled steel; electro-galvanized steel, such as hot dip electro-galvanized steel or electro-galvanized iron-zinc steel; or aluminum.

Prior to applying the compositions, it is often advisable to pre-treat the relevant surfaces to remove foreign matter there from: this step can, if applicable, facilitate the subsequent adhesion of the compositions thereto. Such treatments are known in the art and can be performed in a single or multi-stage manner constituted by, for instance, immersion in a waterborne alkaline degreasing bath; treatment with a waterborne cleaning emulsion; treatment with a cleaning solvent, such as carbon tetrachloride or trichloroethylene; and, water rinsing, preferably with deionized or demineralized water. In those instances where a waterborne alkaline degreasing bath is used, any of the degreasing agent remaining on the surface should desirably be removed by rinsing the substrate surface with deionized or demineralized water.

The compositions are then applied to the preferably pre-treated, optionally primed surfaces of the substrate by conventional application methods such as: brushing; roll coating; doctor-blade application; printing methods; and, spraying methods, including but not limited to air-atomized spray, air-assisted spray, airless spray and high-volume low-pressure spray.

The thickness of the applied coating in the present invention may be adjusted such that the final cured coating is effective in suppressing noise and vibration transmission to the desired extent. In many instances, the compositions will be applied to a wet film thickness of from 1 to 5 mm. The application of thinner layers within this range is more economical and provides for a reduced likelihood of deleterious thick cured regions. However, great control must be exercised in applying thinner coatings or layers so as to avoid the formation of discontinuous cured films.

The curing of the compositions of the invention typically occurs at temperatures in the range of from 80 °C to 200 °C, preferably from 90 °C to 180 °C. The temperature that is suitable depends on the specific compounds present and the desired curing rate and can be determined in the individual case by the skilled artisan, using simple preliminary tests if necessary.

### LISTING OF EMBODIMENTS

Embodiment 1. An aqueous acoustic damping composition comprising:
a) an acrylic polymer,
b) at least a filler,
c) a starch,
d) an anti-shocking agent, and
e) a rosin ester,
   wherein the anti-shocking agent being an ester based anti-shocking agent.

Embodiment 2. The aqueous acoustic damping composition of Embodiment 1, wherein the anti-shocking agent comprise ester compounds being represented by the following formulas:

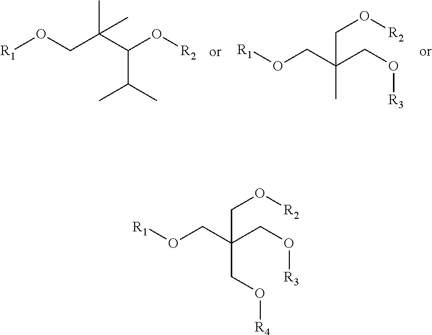

wherein, independently, R₁, R₂, R₃ and R₄ each independently representing H or

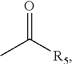

and R₅ representing straight-chain or branched alkyl group having 1 to 18 carbons.

Embodiment 3. The aqueous acoustic damping composition of any one of preceding Embodiments, wherein R₅ represents straight-chain or branched alkyl group having preferably 1 to 4 carbons.

Embodiment 4. The aqueous acoustic damping composition of any one of preceding Embodiments, wherein R₅ represents n-propyl, isopropyl, n-butyl and isobutyl.

Embodiment 5. The aqueous acoustic damping composition of any one of preceding Embodiments, wherein the aqueous acoustic damping composition comprises from 0.3 to 6.0 parts by weight of anti-shocking agent.

Embodiment 6. The aqueous acoustic damping composition of any one of preceding Embodiments, wherein the aqueous acoustic damping composition comprises from 0.4 to 5.0 parts by weight of anti-shocking agent.

Embodiment 7. The aqueous acoustic damping composition of any one of preceding Embodiments, wherein the rosin ester has a softening point of from 50 °C to 130 °C, preferably from 60 °C to 120 °C and more preferably from 70 °C to 110 °C.

Embodiment 8. The aqueous acoustic damping composition of any one of preceding Embodiments, wherein the aqueous acoustic damping composition comprises from 1.0 to 3.0 parts by weight of rosin ester.

Embodiment 9. The aqueous acoustic damping composition of any one of preceding Embodiments, wherein the acrylic polymer comprises 10-50% by weight of styrene-based monomers, based on the total acrylic polymer.

Embodiment 10. The aqueous acoustic damping composition of any one of preceding Embodiments, wherein the aqueous acoustic damping composition further comprises from 0.1 to 1.0 parts by weight of thickener, and/or 0.1 to 0.5 parts by weight of expandable microspheres.

Embodiment 11. The aqueous acoustic damping composition of any one of preceding Embodiments, wherein, based on the total weight of the aqueous acoustic damping composition, comprises:
a) 5.0 to 15.0 parts by weight of the acrylic polymer,
b) 55.0 to 75.0 parts by weight of the filler,
c) 1.0-5.0 parts by weight of the starch,
d) 0.3-6.0 parts by weight of the anti-shocking agent, and
e) 0.5 to 5.0 parts by weight of the rosin ester.

Embodiment 12. The aqueous acoustic damping composition of any one of preceding Embodiments, wherein the aqueous acoustic damping composition comprises from 5.0 to 30.0 parts by weight of water as a liquid phase.

Embodiment 13. A damping coating comprising a cured product of the aqueous acoustic damping composition according to any one of claims 1-12.

Embodiment 14. The damping coating of Embodiment 13, wherein, within a temperature range of 20 °C to 30 °C, the loss factor of the damping composition is equal to or greater than 0.12, or preferably equal to or greater than 0.13, or preferably equal to or greater than 0.15.

Embodiment 15. An article comprising a substrate and a damping coating disposed on the substrate and the second substrate, wherein the damping coating is the cured product of the aqueous acoustic damping composition according to any one of Embodiments 1-12.

Embodiment 16. An automotive panel, comprises an article of Embodiment 15.

### Examples

The present invention will be further described and illustrated in detail with reference to the following examples. The examples are intended to assist one skilled in the art to better understand and practice the present invention, however, are not intended to restrict the scope of the present invention. All numbers in the examples are based on weight unless otherwise stated.

### Raw Materials

| Product name | Description/function | Source |
|---|---|---|
| CC-600 | CaCO₃/ filler | Jiangxi GuangYuan Chemical (CN) |
| ZG200 | CaCO₃/ filler | Shijiazhuang Daheng (CN) |
| AEPD VOX 1000 | Amine/ pH adjustment | ANGUS Chemical (CN) |
| Propylene glycol | Coalescent agent | Dow Chemical (CN) |
| Zetasperse 3100 | Polymeric surface-active agent | Evonik (Essen, Germany) |
| Tergitol 15-S-40 | Surface-active agent | Dow Chemical (CN) |
| Tego IS 9520 | Deformer | Evonik (Essen, Germany) |
| BYK-012 | Deformer | BYK Chemical (Germany) |
| 031 WUFX40 | Blowing agent | Akzo Nobel (Duluth, GA) |
| Farinex VA70 | Starch | Avebe (Netherlands) |
| Eastman TXIB | Anti-shocking agent | Eastman (Singapore) |
| Texanol Ester Alcohol | Anti-shocking agent | Eastman (US) |
| DOA | Plasticizer | ExxonMobil Chemical (CN) |
| DINP | Plasticizer | BASF (CN) |
| Viscoatex 730 | Thickener | Arkema (CN) |
| Thixol 53 L | Thickener | Arkema (CN) |
| Acronal 4569 ap | Acrylic emulsion | BASF (CN) |
| Antamp 0652 | Acrylic emulsion | Wanhua Chemical (CN) |
| Eastman 38276 | Rosin emulsion | Eastman (PA, USA) |

* All raw materials are directly used without any special treatment.

### Example 1

### Preparation of Aqueous Acoustic Damping Composition

Compositions of the invention comprise the following raw materials at the indicated levels. The compositions were obtained by first adding the liquid materials to a vessel and mixing at 5 °C-25 °C. The powder filler materials were then added and mixed until a smooth homogeneous paste was obtained. The rheological additives and water were then added with mixing to adjust the desired viscosity. Vacuum is preferred during mixing to reduce the trapped air bubbles.

### Curing of Aqueous Acoustic Damping Composition

The compositions were applied to the substrate by manual brushing. The thickness was controlled from about 1 mm to about 5 mm (e.g., from about 2 to about 4 mm). After application on the substrate, the composition was typically baked for at least about 10 minutes, more typically from about 15 to about 30 minutes. For E1 to E7, CE1 to CE10, the curing of the compositions was performed at about 150 °C for 20 mins.

### Example 2-7, and CE1-CE10

The aqueous acoustic damping compositions of E2 to E7, CE1 to CE10 were prepared in reference to Example 1. The aqueous acoustic damping composition of E2 to E7 and CE1 to CE10 were cured in reference to Example 1. More details are listed in below result part.

### Test Methods

### Damping Coefficient Test

The damping test was carried out by TWS Michael Schulthes obster test system on the water-based damping coatings prepared in the selected Examples and Comparative Examples. The specific damping test method was tested in accordance with the provisions of GB/T 18258-2000. The size of the steel plate was 240 mm×10 mm×1 mm. The size of the water-based damping paint was 216 mm×10 mm×3.0 mm and baked at standard curing conditions. Before testing, the samples were left at room temperature for at least 24 h. The damping coefficient test was carried out under the temperature ranging from −40 °C to 60 °C and the measurement was tested every 2.5 °C when the temperature was stable. The composite loss factor at a frequency of 200 Hz was recorded and normalized by the area density of 3 kg/cm³. The damping coefficient measurement results are shown in Table 1.

Damping coefficient results are recorded and ranked as follows:
Not pass: within the temperature range of 20 °C to 30 °C, the loss factor is less than 0.12;
Pass: within the temperature range of 20 °C to 30 °C, the loss factor is equal to or greater than 0.12.

### Open Time Test

The compositions were first applied to the substrate by manual brushing. The size of samples was 12 cm*8 cm with a thickness of 3.5 mm. The samples were left at 25 °C and 50% RH for 24 h before curing at 150 °C for 20 min.

Open time test results are recorded and ranked as follows:
Not pass: blister size is greater than 20 mm after baking; or sagging is equal to or greater than 2 mm after baking.
Pass: blister size is equal to or greater than 5 mm, and equal to or less than 20 mm after baking; or surface cracks size is equal to or greater than 20 mm.
Excellent: no blisters or blister size is less than 5 mm after baking; and surface cracks size is less than 20 mm.

### Cold Drop Test

The compositions were first applied to the substrate by manual brushing. The size of the applied coating was 16 cm*7 cm with a thickness of 2 mm. The samples were left at 25 C 50% RH for 10 min before curing at 150 °C for 20 min. The samples were cooled at 25 °C and 50% RH for 24 h and placed at a cold chamber at −30 °C for 2 h. Immediately after the pattern plate was taken out of the cold chamber, the cold drop test was performed. A steel ball (diameter: 40 mm, weight: circa 250 g) was dropped on the backside of the substrate at a height of 400 mm.

Cold drop test results are recorded and ranked as follows:
Not pass: the sample is chipping-off or formed deep cracks down to the substrate;
Pass: the sample stay intact, or only surface cracks are formed on the surface of the samples.

TABLE 1
Shows the aqueous acoustic damping compositions of E1-E7

| Product name | E1 | E2 | E3 | E4 | E5 | E6 | E7 |
|---|---|---|---|---|---|---|---|
| CC-600 | 31.42 | 33.58 | 33.52 | 0.00 | 33.52 | 33.52 | 32.69 |
| CaCO₃-ZG200 | 31.42 | 34.70 | 34.64 | 68.58 | 34.64 | 34.64 | 34.87 |
| AEPD VOX 1000 | 0.19 | 0.19 | 0.13 | 0.13 | 0.13 | 0.13 | 0.19 |
| Propylene glycol | 3.37 | 1.51 | 1.51 | 1.49 | 1.51 | 1.51 | 3.27 |
| Zetasperse 3100 | 0.30 | 0.34 | 0.34 | 0.30 | 0.34 | 0.34 | 0.32 |
| Tergitol 15-S-40 | 0.00 | 0.16 | 0.16 | 0.15 | 0.16 | 0.16 | 0.15 |
| Tego IS 9520 | 0.03 | 0.03 | 0.02 | 0.02 | 0.00 | 0.00 | 0.03 |
| BYK-012 | 0.00 | 0.00 | 0.00 | 0.00 | 0.08 | 0.08 | 0.00 |
| 031 WUFX40 | 0.17 | 0.17 | 0.17 | 0.17 | 0.17 | 0.17 | 0.16 |
| Farinex VA70 | 3.37 | 2.91 | 2.91 | 2.88 | 2.91 | 2.91 | 2.83 |
| water | 13.97 | 14.71 | 14.16 | 13.27 | 13.39 | 13.37 | 14.49 |
| TXIB | 4.49 | 0.90 | 1.68 | 1.99 | 2.01 | 0.00 | 0.44 |
| Texanol Ester | 0.00 | 0.00 | 0.00 | 0.00 | 0.00 | 2.03 | 0.00 |
| Alcohol | | | | | | | |
| DOA | 0.00 | 0.00 | 0.00 | 0.00 | 0.00 | 0.00 | 0.00 |
| DINP | 0.00 | 0.00 | 0.00 | 0.00 | 0.00 | 0.00 | 0.00 |
| Viscoatex 730 | 0.24 | 0.17 | 0.00 | 0.00 | 0.00 | 0.00 | 0.20 |
| Thixol 53 L | 0.00 | 0.00 | 0.15 | 0.15 | 0.15 | 0.15 | 0.00 |
| Acronal 4569 | 0.00 | 9.40 | 9.39 | 0.00 | 0.00 | 0.00 | 9.15 |
| Antamp 0652 | 9.80 | 0.00 | 0.00 | 9.66 | 9.76 | 9.76 | 0.00 |
| Eastman 38276 | 1.23 | 1.23 | 1.23 | 1.22 | 1.23 | 1.23 | 1.20 |

TABLE 2
shows testing results of the aqueous acoustic damping compositions E1-E7.

| Test item | E1 | E2 | E3 | E4 | E5 | E6 | E7 |
|---|---|---|---|---|---|---|---|
| Cold drop test | Pass | Pass | Pass | Pass | Pass | Pass | Pass |
| 24 h Open time | Excellent | Excellent | Excellent | Excellent | Excellent | Excellent | Pass |
| Damping | Pass | Pass | Pass | Pass | Pass | Pass | Pass |

In Examples 1 to 7, the aqueous acoustic damping compositions were prepared according to the formulations provided by the present invention. These formulations especially included the acrylic polymer, filler, starch, anti-shocking agent, and rosin ester. It can be seen that when the contents of the claimed components of the present invention are within certain ranges, anti-shocking agent can act synergistically with rosin ester such that the prepared aqueous acoustic damping compositions have both good acoustic performance and good anti-shocking performance at low temperature (represented by the cold drop test result) is demanding. It can be seen from E7, for ensuring both good acoustic performance and good anti-shocking performance, the aqueous acoustic damping composition comprises a suitable anti-shocking agent in an amount of at least 0.44 parts by weight. E1 to E6 show that the acoustic performance improved with the increase of the anti-shocking agent.

TABLE 3
shows the aqueous acoustic damping compositions of CE1-CE10.

| Product name | CE1 | CE2 | CE3 | CE4 | CE5 | CE6 | CE7 | CE8 | CE9 | CE10 |
|---|---|---|---|---|---|---|---|---|---|---|
| CC-600 | 33.52 | 33.49 | 31.60 | 31.60 | 33.52 | 31.46 | 32.07 | 33.52 | 33.52 | 33.48 |
| CaCO₃-ZG200 | 34.64 | 34.61 | 31.60 | 31.60 | 34.64 | 31.46 | 32.07 | 34.64 | 34.64 | 34.60 |
| AEPD VOX 1000 | 0.13 | 0.13 | 0.19 | 0.19 | 0.13 | 0.19 | 0.19 | 0.13 | 0.13 | 0.13 |
| Propylene glycol | 1.51 | 1.51 | 3.39 | 3.39 | 1.51 | 3.37 | 3.44 | 1.51 | 1.51 | 1.51 |
| Zetasperse 3100 | 0.34 | 0.34 | 0.30 | 0.30 | 0.34 | 0.30 | 0.31 | 0.34 | 0.34 | 0.34 |
| Tergitol 15-S-40 | 0.16 | 0.16 | 0.00 | 0.00 | 0.16 | 0.00 | 0.00 | 0.16 | 0.16 | 0.16 |
| Tego IS 9520 | 0.02 | 0.02 | 0.03 | 0.03 | 0.02 | 0.03 | 0.03 | 0.00 | 0.00 | 0.02 |
| BYK-012 | 0.00 | 0.00 | 0.00 | 0.00 | 0.00 | 0.00 | 0.00 | 0.08 | 0.08 | 0.00 |
| 031 WUFX40 | 0.17 | 0.17 | 0.17 | 0.17 | 0.17 | 0.17 | 0.17 | 0.17 | 0.17 | 0.17 |
| Farinex VA70 | 2.91 | 2.90 | 3.39 | 3.39 | 2.91 | 3.37 | 3.44 | 2.91 | 2.91 | 2.90 |
| water | 15.46 | 15.52 | 18.00 | 16.84 | 13.52 | 12.82 | 16.55 | 13.35 | 13.33 | 16.01 |
| TXIB | 0.00 | 0.00 | 0.00 | 0.00 | 2.01 | 6.74 | 0.23 | 0.00 | 0.00 | 0.00 |
| Texanol Ester | 0.00 | 0.00 | 0.00 | 0.00 | 0.00 | 0.00 | 0.00 | 0.00 | 0.00 | 0.00 |
| Alcohol | | | | | | | | | | |
| DOA | 0.00 | 0.00 | 0.00 | 0.00 | 0.00 | 0.00 | 0.00 | 2.05 | 0.00 | 0.00 |
| DINP | 0.00 | 0.00 | 0.00 | 1.16 | 0.00 | 0.00 | 0.00 | 0.00 | 2.07 | 0.00 |
| Viscoatex 730 | 0.00 | 0.00 | 0.24 | 0.24 | 0.00 | 0.20 | 0.25 | 0.00 | 0.00 | 0.00 |
| Thixol 53 L | 0.15 | 0.18 | 0.00 | 0.00 | 0.15 | 0.00 | 0.00 | 0.15 | 0.15 | 0.19 |
| Acronal 4569 | 0.00 | 0.00 | 0.00 | 0.00 | 0.00 | 0.00 | 0.00 | 0.00 | 0.00 | 0.00 |
| Antamp 0652 | 9.76 | 9.75 | 9.86 | 9.86 | 10.92 | 8.65 | 10.00 | 9.76 | 9.76 | 10.49 |
| Eastman 38276 | 1.23 | 1.23 | 1.24 | 1.24 | 0.00 | 1.24 | 1.26 | 1.23 | 1.23 | 0.00 |

TABLE 4
Testing results of the aqueous acoustic damping compositions CE1-CE10.

| Test item | CE1 | CE2 | CE3 | CE4 | CE5 | CE6 | CE7 | CE8 | CE9 | CE10 |
|---|---|---|---|---|---|---|---|---|---|---|
| Cold | Not | Not | Not | Not | Not | Pass | Not | Pass | Pass | Not |
| drop test | Pass | Pass | Pass | Pass | Pass | | Pass | | | Pass |
| 24 h | A | A | A | Pass | A | Not | A | A | A | Pass |
| Open | | | | | | Pass | | | | |
| time | | | | | | | | | | |

“A” indicates result grade Excellent.

In comparative examples 1-4, the aqueous acoustic damping compositions were prepared without anti-shocking agent. The cured aqueous acoustic damping compositions can't pass cold drop test, and then don't have good anti-shocking performance at low temperature. In comparative example 5, the aqueous acoustic damping compositions were prepared without rosin ester. The cured aqueous acoustic damping compositions don't have desired anti-shocking performance at low temperature either. In comparative example 6, the amount of anti-shocking agent is higher than the desired amount. It can be seen that excess amount of anti-shocking agent has negative impact on open time. Although the sample could pass the cold drop test, but it is not qualified for damping test due to the swell. The amount of anti-shocking agent in comparative example 7 is less than desired amount, and the aqueous acoustic damping composition with insufficient amount of anti-shocking agent can't pass the cold drop test.

The aqueous acoustic damping compositions focus on some properties like good acoustic performance and good anti-shocking performance at low temperature (e.g. −30 °C).

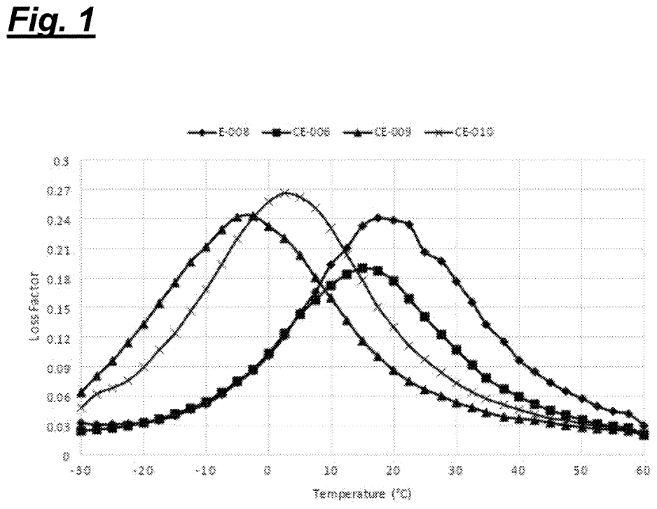

FIG. 1 shows the damping coefficient measurement results of E5, CE5, CE8 and CE9. It can be seen from the damping coefficient measurement results of E5 and CE5, the existing of rosin ester contributes on the loss factor peek value and enhance the loss factor value in the temperature range of 20 °C to 30 °C to greater than 1.2.

In comparative examples CE8 and CE9, the aqueous acoustic damping compositions don't comprise any anti-shocking agents but conventional plasticizers, such as DOA or DINP. And CE8, CE9 and E5 comprise the same acrylic emulsion as main polymer. Compared with the test results of E5 and CE8/CE9, the aqueous acoustic damping compositions without anti-shocking agents have a loss factor of less than 0.12 in the temperature range of 20 °C to 30 °C. The conventional plasticizers, such as ester compounds DOA and DINP, which play a role as small molecule plasticizer, could increase the flexibility of the aqueous acoustic damping compositions, thus the samples could pass the cold drop test. But the conventional plasticizers move the loss factor peek value of the polymer compositions to lower temperature range, which gives a negative impact on the acoustic damping performance. Without the anti-shocking agent, the damping tests failed.

In present invention, it is surprisingly found that the aqueous acoustic damping compositions comprising both ester-based anti-shocking agent and rosin ester have good acoustic performance and good anti-shocking performance at low temperature simultaneously.

What is claimed is:

1. An aqueous acoustic damping composition comprising:
a) an acrylic polymer,
b) at least a filler,
c) a starch,
d) an anti-shocking agent, and
e) a rosin ester,
wherein the anti-shocking agent being an ester based anti-shocking agent.

2. The aqueous acoustic damping composition of claim 1, wherein the anti-shocking agent comprise ester compounds being represented by the following formulas: 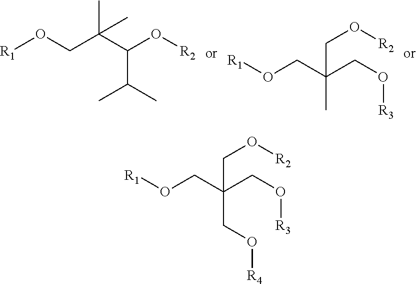
wherein, independently, R₁, R₂, R₃ and R₄ each independently representing H or 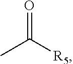
and R₅ representing straight-chain or branched alkyl group having 1 to 18 carbons.

3. The aqueous acoustic damping composition of claim 2, wherein R₅ represents straight-chain or branched alkyl group having 1 to 4 carbons.

4. The aqueous acoustic damping composition of claim 2, wherein R₅ represents n-propyl, isopropyl, n-butyl and isobutyl.

5. The aqueous acoustic damping composition of claim 1, wherein the aqueous acoustic damping composition comprises from 0.3 to 6.0 parts by weight of anti-shocking agent.

6. The aqueous acoustic damping composition of claim 1, wherein the aqueous acoustic damping composition comprises from 0.4 to 5.0 parts by weight of anti-shocking agent.

7. The aqueous acoustic damping composition of claim 1, wherein the rosin ester has a softening point of from 50 °C to 130 °C.

8. The aqueous acoustic damping composition of claim 1, wherein the aqueous acoustic damping composition comprises from 0.5 to 5.0 parts by weight of rosin ester.

9. The aqueous acoustic damping composition of claim 1, wherein the acrylic polymer comprises 10-50% by weight of styrene-based monomers, based on the total acrylic polymer.

10. The aqueous acoustic damping composition of claim 1, wherein the aqueous acoustic damping composition further comprises from 0.1 to 1.0 parts by weight of thickener, and/or 0.1 to 0.5 parts by weight of expandable microspheres.

11. The aqueous acoustic damping composition of claim 1, wherein, based on the total weight of the aqueous acoustic damping composition, comprises:
a) 5.0 to 15.0 parts by weight of the acrylic polymer,
b) 55.0 to 75.0 parts by weight of the filler,
c) 1.0-5.0 parts by weight of the starch,
d) 0.3-6.0 parts by weight of the anti-shocking agent, and
e) 0.5 to 5.0 parts by weight of the rosin ester.

12. The aqueous acoustic damping composition of claim 1, wherein the aqueous acoustic damping composition comprises from 5.0 to 30.0 parts by weight of water as a liquid phase.

13. A damping coating comprising a cured product of the aqueous acoustic damping composition according to claim 1.

14. The damping coating of claim 13, wherein, within a temperature range of 20 °C to 30 °C, the loss factor of the damping composition is equal to or greater than 0.12.

15. An article comprising a substrate and a damping coating disposed on the substrate and the second substrate, wherein the damping coating is the cured product of the aqueous acoustic damping composition according to claim 1.

16. An automotive panel, comprises an article of claim 15.
